(19) United States
(12) Patent Application Publication
(10) Pub. No.: US 2026/0220825 A1
(43) Pub. Date: Jul. 30, 2026

(54) IMAGE/VIDEO COMPRESSION WITH SCALABLE LATENT REPRESENTATION

(71) Applicant: InterDigital VC Holdings, Inc., Wilmington, DE (US)

(72) Inventors: Wei JIANG, Sunnyvale, CA (US); Hyomin CHOI, Sunnyvale, CA (US); Fabien RACAPE, San Francisco, CA (US)

(21) Appl. No.: 19/158,222

(22) PCT Filed: Feb. 22, 2024
(86) PCT No.: PCT/US2024/016895

§ 371 Date: Aug. 20, 2025

Related U.S. Application Data
(60) Provisional application No. 63/447,697, filed on Feb. 23, 2023.

(51) Int. Cl. G06T 9/00

(52) U.S. Cl. CPC G06T 9/002

(57) ABSTRACT

At least a method and an apparatus are presented for efficiently encoding or decoding video, for example human-centric video content. For example, at least one embodiment using a scalable latent representation comprising a generic codebook-based representation and a low-quality latent representation of a video. According to another embodiment, the scalable latent representation further comprises a domain-adaptive codebook-based representation. Advantageously, such scalable latent representation provides, for content such as human-centric video, a domain-adaptive and task-adaptive video coding framework that can be flexibly configured to accommodate both human and machine consumption.

### CROSS-REFERENCE TO RELATED APPLICATIONS

This application claims the benefit of U.S. Patent Application No. 63/447,697, filed on Feb. 23, 2023, which is incorporated herein by reference in its entirety.

### TECHNICAL FIELD

At least one of the present embodiments generally relates to a method or an apparatus for video encoding or decoding in the context of human-centric video content, for both tasks aiming at human consumption like video conferencing and/or tasks aiming at machine consumption like face recognition. More particularly, at least one of the present embodiments relates to a method or an apparatus for decoding a video using a scalable latent representation comprising a generic codebook-based representation and a low-quality latent representation of the video.

### BACKGROUND

It is essentially important to effectively compress and transmit human-centric videos for a variety of applications, such as video conferencing, video surveillance, etc. By and large, standard video codecs such as AVC, HEVC and VVC have been developed for compressing natural image/video data. In recent years, end-to-end Learned Image Coding (LIC) or video coding based on Neural Networks (NN) have also been developed. Currently MPEG is exploring these technologies. The video coding tools in prior video codecs are designed to improve coding efficiency for general image and video content, some specially designed for screen contents. They are not optimized for the human-centric videos. In most cases, human faces are the primary content of such videos. For example, the primary people talking at the center of the video frame are the focus of video conferencing videos, or the detected faces are the main focus of many surveillance videos. Since facial attributes are widely shared between people from the structural perspective, such characteristics can be efficiently coded with common representations that cost much less bits to transfer than compressing original pixels with off-the-shelf codecs. This enables a coding framework to compress the face with extremely low bitrate and to reconstruct the face with decent quality.

Depending on different applications, the requirements of video compression vary in practice. For example, in tasks mainly for human consumption such as video conferencing, faces need to be restored with high-perceptual-quality so that the decoded video looks realistic and pleasant to human eyes. In tasks mainly for machine consumption such as face recognition in surveillance domain, identity-preserving cues need to be restored so that decoded videos can maintain the recognition accuracy for further analysis by machine. Previous methods, in general, treat different applications separately, where a video coding framework is customized for either human consumption or machine consumption. So far, no existing method can provide a generic video coding framework that can be flexibly configured to accommodate both human and machine consumption.

### SUMMARY

In end-to-end compression, a deep neural network-based encoder can be used to encode an image. The embeddings output from the encoder are quantized and encoded with a lossless encoder. Advantageously, at least one embodiment allows improving the latent coding by further reducing the redundancies in the quantized latent by using a scalable latent representation comprising a generic codebook-based representation and a low-quality latent representation of a sequence of images. According to another embodiment, the scalable latent representation further comprises a domain-adaptive codebook-based representation. Advantageously, such scalable latent representation provides, for content such as human-centric video, a domain-adaptive and task-adaptive video coding framework that can be flexibly configured to accommodate both human and machine consumption.

To that end, at least one embodiment discloses receiving a scalable latent representation comprising a generic codebook-based representation and a low-quality latent representation of a sequence of images; obtaining a reconstructed generic codebook-based feature representative of image data samples reconstructed from the generic codebook-based representation; decoding the low-quality latent representation to obtain a reconstructed low-quality image; applying to reconstructed low-quality image, a neural network-based embedding feature processing to generate a low-quality feature representative of a feature of image data samples; and applying to the reconstructed generic codebook-based feature and to the low-quality feature, a neural network-based reconstruction processing to generate a reconstructed image adapted to a plurality of computer vision tasks including both machine consumption and human consumption. In a variant embodiment, the scalable latent representation further comprises domain-adaptive codebook-based representation.

According to another aspect, at least one embodiment discloses obtaining a sequence of images to encode; applying to sequence of images, a neural network-based generic embedding feature processing to generate a generic feature representative of a generic feature of image data samples; obtaining a generic codebook-based representation based on generic feature and on a generic codebook; downsampling an image of the sequence of images to obtain low-quality image; encoding low-quality image to obtain a low-quality latent representation; and associating the generic codebook-based representation and the low-quality latent representation of the sequence of images to form a scalable latent representation of the sequence of images adapted to a plurality of computer vision tasks including both machine consumption and human consumption.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF DRAWING

FIG. 1 illustrates a block diagram of a system within which aspects of the present embodiments may be implemented.

FIG. 2 illustrates a block diagram of a generic embodiment of traditional video encoder.

FIG. 3 illustrates a block diagram of a generic embodiment of traditional video encoder.

FIG. 4 illustrates a general workflow of AI-based human-centric video compression system according to an embodiment.

FIG. 5a and FIG. 5b illustrate a workflow of video compression for machine consumption according to various prior art.

FIG. 6 illustrates a workflow of a novel human-centric video coding solution according to an embodiment.

FIG. 7 illustrates a workflow of the reconstruction module according to an embodiment.

FIG. 8 and FIG. 9 illustrate a workflow of the online adaptive learning according to various embodiments.

FIG. 10 illustrates a decoding method according to an embodiment.

FIG. 11 illustrates an encoding method according to an embodiment.

FIG. 12 shows two examples of an original and reconstructed image according to at least one embodiment.

FIG. 13 shows an example of application to which aspects of the present embodiments may be applied.

FIG. 14 shows two remote devices communicating over a communication network in accordance with an example of present principles in which various aspects of the embodiments may be implemented.

FIG. 15 shows the syntax of a signal in accordance with an example of present principles.

### DETAILED DESCRIPTION

Various embodiments relate to a video coding system in which, in at least one embodiment, it is proposed to adapt video encoding/decoding tools to hybrid machine/human vision applications. Different embodiments are proposed hereafter, introducing some tools modifications to increase coding efficiency and improve the codec consistency when both applications are targeted. Amongst others, a decoding method, an encoding method, a decoding apparatus and an encoding apparatus implementing a scalable latent representation of a video providing a domain-adaptive and a task-adaptive video bitstream that can be flexibly configured to accommodate both human and machine consumption at the decoder are proposed.

The present aspects are described in the context of ISO/MPEG Working Group 2, called Video Coding for Machine (VCM) and of JPEG-AI. The Video Coding for Machines (VCM) is an MPEG activity aiming to standardize a bitstream format generated by compressing either a video stream or previously extracted features. The bitstream should enable multiple machine vision tasks by embedding the necessary information for performing multiple tasks at the receiver, such as segmentation, object tracking, face recognition, video conferencing, as well as reconstruction of the video contents for human consumption. In parallel, JPEG is standardizing JPEG-AI which is projected to involve end-to-end NN-based image compression method that is also capable to be optimized for some machine analytics tasks. One can easily envision other similar flavor of standards and forthcoming systems in the near future for VCM paradigm as use cases are already ubiquitous such as video surveillance, autonomous vehicles, smart cities etc.

The present aspects are not limited to those standardization works and can be applied, for example, to other standards and recommendations, whether pre-existing or future-developed, and extensions of any such standards and recommendations. Unless indicated otherwise, or technically precluded, the aspects described in this application can be used individually or in combination.

The acronyms used herein are reflecting the current state of video coding developments and thus should be considered as examples of naming that may be renamed at later stages while still representing the same techniques.

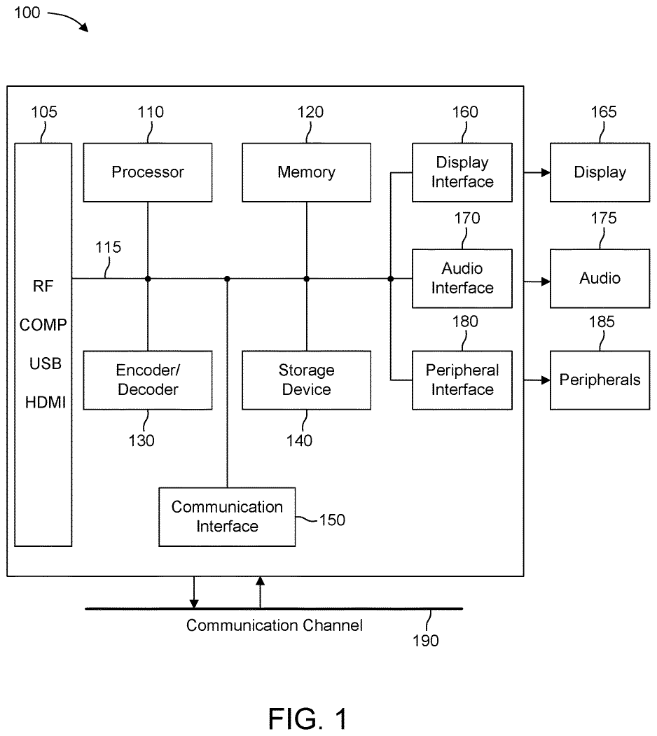

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, MPEG-4, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the 12C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

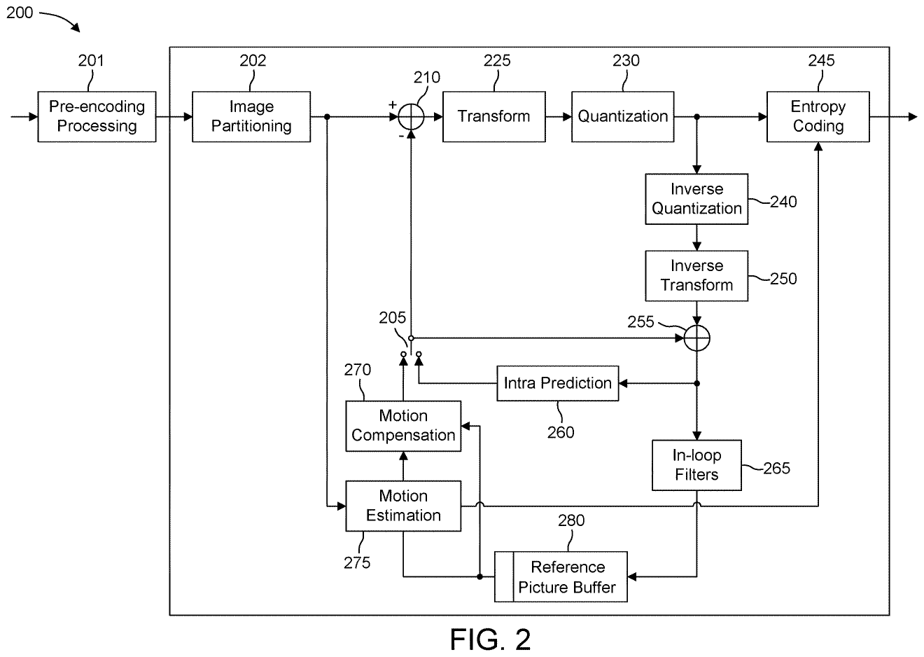

FIG. 2 illustrates an example video encoder 200, such as VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

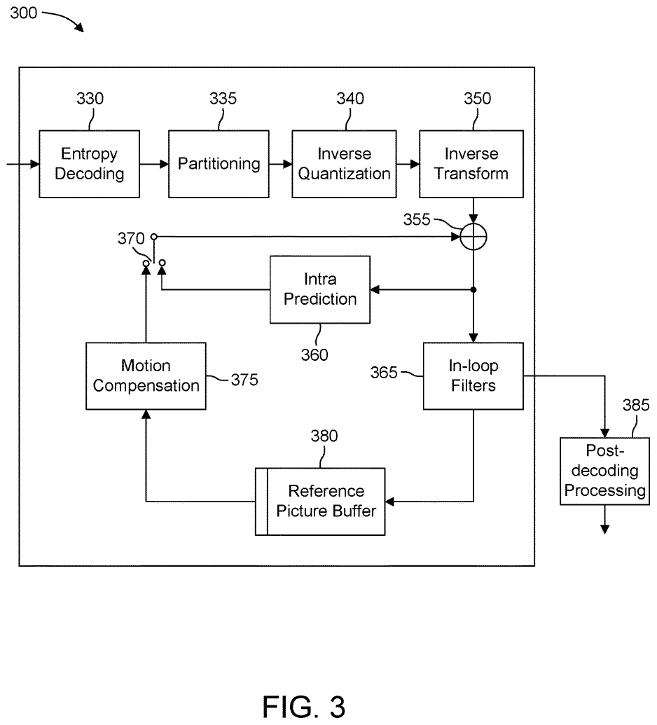

FIG. 3 illustrates a block diagram of an example video decoder 300, such as VVC decoder. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

Depending on different applications, the requirements of video compression vary in practice. For example, in tasks mainly for human consumption such as video conferencing, faces of a human-centric video need to be restored with high-perceptual-quality so that the decoded video looks realistic and pleasant to human eyes. In tasks mainly for machine consumption such as face recognition in surveillance, identity-preserving cues need to be restored so that decoded videos can maintain the recognition accuracy for further analysis by machine. Previous compression methods, in general, treat different applications separately, where a video coding framework is customized for either human consumption or machine consumption. So far, no existing method can provide a generic video coding framework that can be flexibly configured to accommodate both human and machine consumption. Although, the recent MPEG VCM standardization activity studies the joint optimization framework of the video coding algorithm with the end computer vision task for which decoded videos are used. Such a framework is quite rigid. The video coding method is optimized for the end computer vision task, and it cannot work well for other tasks or even for a different model of the same end computer vision task. It is highly desired that a video coding framework for machine consumption can be flexible and scalable to different task models and to different end computer vision tasks.

For general human-centric video compression, given a set of input video frames I₁ . . . , I_{N}, an Encoder generates a compressed representation Lᵢ for each video frame Iᵢ, which requires less bits than the original input video frame I_{I} to send to a Decoder. It can correspond to a filtered or degraded version of the image which makes it more compressible, or a sub-sampled version. The Decoder recovers the output video frame Î_{I} based on the received compressed representation Lᵢ, and the previously received L₁ . . . , Lᵢ₋₁. For applications targeting human consumption, the goal is to minimize both the restoration distortion D(Iᵢ, Îᵢ) (e.g., MSE or SSIM) and the bitrate R(Lᵢ). For applications targeting at machine consumption, the goal is to minimize the task loss L(Îᵢ) (e.g., recognition errors) and the bitrate R(Lᵢ).

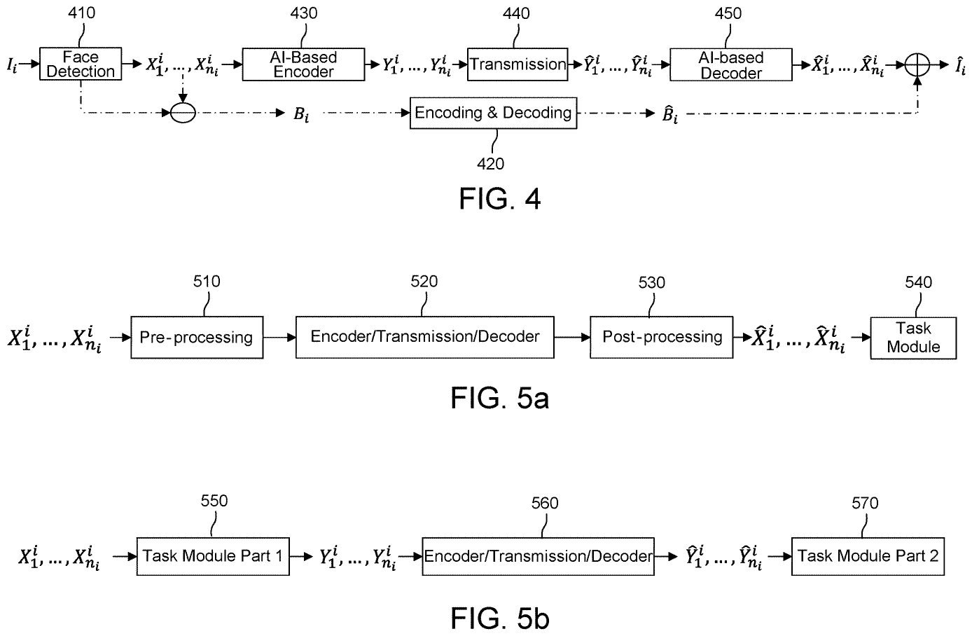

FIG. 4 illustrates a general workflow of AI-based human-centric video compression system according to an embodiment. Each input frame Iᵢ is fed into a Face Detection module 410 and human faces

$${X}_{1}^{i} , … , {X}_{{n}_{i}}^{i}$$

are detected. Each face

$${X}_{j}^{i}$$

is a cropped region in Iᵢ defined by a bounding box containing the detected human face in the center with some extended areas. For example, the region is centered at the center of the detected face and the width and height of the bounding box are a times and b times of the width and height of the face respectively (a≥1, b≥1). The present aspects do not put any restrictions on the face detection method or how to crop the bounding box of the face region. Also, one can decide to only consider some detected faces (e.g., the largest faces or the faces in the center of the video frame). The present aspects do not put restrictions on how many faces or what faces to consider either.

Let Bᵢ denote the remaining background pixels in frame Iᵢ that are not included in any of the human faces one decides to consider. There can be different ways for the video compression system to process Bᵢ. For example, an optional Encoding & Decoding module 420 can aggressively compress Bᵢ by traditional HEVC/VVC as described with FIG. 2 and FIG. 3, or end-to-end Learned Image Coding LIC, or NN-based learned video coding, which is then transmitted to the decoder where a decoded \hat{B}ᵢ can be obtained. In some cases, Bᵢ can be simply discarded, e.g., when a predefined virtual background is used. How to process the background pixels Bᵢ is out of the scope of the present aspects. Therefore, the optional processing flows for Bᵢ are marked by dotted lines on FIG. 4.

For each face

$${X}^{i} , j = 1 , … , {n}_{i}$$

to consider, on the encoder side, an AI-Based Encoder 430 computes a corresponding latent representation

$$1 {y}_{j}^{\dot{t}} , j = 1 , … , {n}_{t} ,$$

which usually consumes less bits to transfer by a Transmission module 440, which also computes a recovered latent representation

$${\hat{Y}}_{j}^{i} , j = 1 , … , {n}_{i}$$

on the decoder side. Usually, the latent representation

$${Y}_{j}^{i}$$

is further compressed in the Transmission module before transmission, e.g., by lossless arithmetic coding, and a corresponding decoding process is needed to recover

$${\hat{Y}}_{j}^{i}$$

in the Transmission module 440. The present aspects do not put any restrictions on the potential further compression and decoding methods of the latent representation. Based on the recovered latent representation

$${\hat{Y}}_{j}^{i} , j = 1 , … , {n}_{i} ,$$

an AI-Based Decoder 450 reconstructs the output face

$${\hat{X}}_{j}^{i} , j = 1 , … , {n}_{i} .$$

In the variant where a decoded background \hat{B}ᵢ is provided, the output face

$${\hat{X}}_{j}^{i} , j = 1 , … , {n}_{i}$$

is merged back with \hat{B}ᵢ to generate the final reconstructed frame Îᵢ. The present aspects do not put any restriction on how to merge

$${\hat{X}}_{j}^{i} , j = 1 , … , {n}_{i}$$

with \hat{B}ᵢ.

Some prior AI-based video compression solutions for human consumption are based on the idea of face reenactment, which transfers the facial motion of one driving face image to another source face image. For instance, given the video frames I₁ . . . , I_{N}, faces

$${X}_{j}^{i} with j = 1 , … , {n}_{i} and i = 1 , … , M$$

in the first M frames (with 1≤M<N) are transmitted to the Decoder with high bitrates to ensure the quality of the decoded faces, by using traditional HEVC/VVC, or LIC or video coding methods. These faces are called source features, which carry the appearance and texture information of the person in the video (assuming consistent visual appearance of the person in the same video). For example, M=1, meaning that the faces (ie the one or more faces) in only one frame are transmitted or for another example, M>1. Then, the faces in the remaining frames

$${X}_{j}^{l} , j = 1 , … , {n}_{l} , l = M + 1 , … , N$$

are called driving faces. Facial landmark keypoints such as on left and right eyes, nose, eyebrows, lips, etc. are extracted from both source frames and driving frames, which carry the pose and expression information of the person. Usually some additional information, such as the 3D head pose, is also computed from both the source and the driving frames. Then for face

$${X}_{j}^{l}$$

in the driving frame Iₗ, using a corresponding face

$${X}_{j}^{i}$$

in the source frame Iᵢ, based on the computed 3D head pose and landmark keypoints, a transformation function can be learned to transfer the pose and expression of the driving face

$${X}_{j}^{l}$$

to the source face

$${X}_{j}^{i} ,$$

and a reenactment neural network is used to generate the output reenacted face

$${X}_{j}^{li} .$$

Then multiple reenacted faces

$${X}_{j}^{li} , i = 1 , … , M$$

using multiple source faces are combined by interpolation to obtain the final output face

$${\hat{X}}_{j}^{l} .$$

The prior face-reenactment-based solution presents severe flaws when applied to realistic faces in the wild. First, due to the difficulty in generating real hair, teeth, accessories, etc., which cannot be accurately described by facial key points only, artifacts are often inevitable. By only applying the reenactment process to the tightly cropped or segmented face regions, the artifacts can be reduced but not eliminated, with additional computation and transmission overhead. In addition, prior solutions are innately unstable, because the reenacted face relies on the appearance and texture information from the source frame and the pose and expression information from another driving frame. The performance suffers from large discrepancy between the source and target faces caused by changes of illuminations, pose, expressions, etc. By maintaining a large pool of candidate source frames and selecting only the ones most similar with the current target driving frame, the problem can be alleviated but not eliminated, with the price of largely increased decoding complexity where one needs to maintain a large pool of source frames in memory and needs to perform the reenactment process multiple times in decoder to compute reenacted faces based on multiple source frames. Therefore, prior face-reenactment-based solution need improvement.

Similarly, prior AI-based video compression solutions for machine consumption also needs improvement. FIG. 5a and FIG. 5b illustrate a workflow of video compression for machine consumption according to various prior art split into two categories. The first category uses a Pre-processing module 510 and/or a Post-processing module 530 before and after the regular video compression pipeline 520, and the decoded data are directly sent to a task module 540 to perform computer vision tasks. For example, for human-centric video compression, the detected faces

$${X}_{j}^{i} , j = 1 , … , {n}_{i}$$

are preprocessed by the Pre-processing module 510, whose output is encoded, transmitted, and decoded by the Encoder/Transmission/Decoder module 520, whose output is then sent to the Post-processing module 530 to generate the reconstructed output face

$${\hat{X}}_{j}^{i} , j = 1 , … , {n}_{i} .$$

$${\hat{X}}_{j}^{i} , j = 1 , … , {n}_{i}$$

which is fed into the Task module 540 to perform computer vision tasks, i.e., viewed by human or further analyzed by machine (e.g., face recognition). In this framework, the Pre-processing and/or Post-processing modules 510, 530 are trained for each specific Task module 540, and the Encoder/Transmission/Decoder module is either traditional video coding methods like HEVC/VVC or learning-based video coding methods.

Different from the first category that keeps the Task module 540 and the compression pipeline 520 separated, methods in the second category merge the processing modules for compression and for performing computer vision tasks more deeply. The task module is usually separated into two parts 550, 570, the first part 550 on the encoder side and the second part 570 on the decoder side. For example, for human-centric video compression, the detected faces

$${X}_{j}^{i} , j = 1 , … , {n}_{i}$$

are fed into a Task module part 1 process 550 to compute the latent representation

$${Y}_{j}^{i} , j = 1 , … , {n}_{i} ,$$

which is encoded, transmitted, and decoded by the Encoder/Transmission/Decoder module 560 to generate the decoded latent representation

$${Y}_{j}^{i} , j = 1 , … , {n}_{i} . {Y}_{j}^{i} , j = 1 , … , {n}_{i}$$

which is directly sent to a task module part 2 process 570 to perform the computer vision tasks. In this framework, it is not necessary to reconstruct faces anymore, and the Encoder/Transmission/Decoder module 560 is optimized for each specific task module part 1 and task module part 2. The Encoder/Transmission/Decoder module 560 is either learning-based video coding methods or traditional video coding methods like HEVC/VVC with learnable processing modules that can be optimized end-to-end.

At least some embodiments relate to a method for decoding a video using a scalable latent representation providing, for content such as human-centric video, a domain-adaptive and task-adaptive video coding framework that can be flexibly configured to accommodate both human and machine consumption.

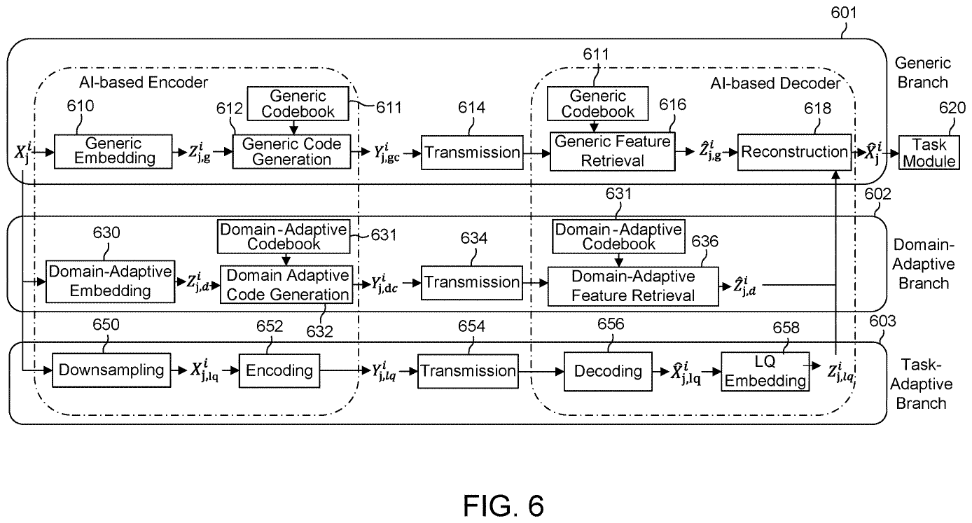

FIG. 6 illustrates a workflow of a novel human-centric video coding solution according to an embodiment. At least one embodiment proposes a novel human-centric video compression framework based on multi-task face restoration. As shown on FIG. 6, three processing branches among a generic branch, a domain-adaptive branch, and a task-adaptive branch, compose the proposed framework and are detailed in the next paragraphs.

For each input face

$${X}_{j}^{i} ,$$

the generic branch 601 generates and transmits a generic integer vector

$${Y}_{i , g c}^{i}$$

indicating the indices of a set of generic codewords. From the generic integer vector the decoder retrieves a rich High Quality (HQ) generic codebook-based feature

$${\hat{Z}}_{j , g}^{i}$$

based on the same HQ generic codebook shared with the encoder. A baseline HQ face can be robustly restored using the HQ generic codebook-based feature.

The domain-adaptive branch 602 generates and transmits a domain-adaptive integer vector

$${Y}_{j , dc}^{i}$$

indicating the indices of a set of domain-adaptive codewords. From the domain-adaptive integer vector, the decoder retrieves a domain-adaptive codebook-based feature based on the same domain-adaptive codebook shared with the encoder. This domain-adaptive codebook-based feature

$${\hat{Z}}_{i , d}^{i}$$

can be combined with the HQ generic codebook-based feature

$${\hat{Z}}_{i , g}^{i}$$

to restore a domain-adaptive face that preserves the details and expressiveness of the current face for the current task domain more faithfully. Advantageously, the HQ generic codebook is learned based on a large amount of HQ training faces to ensure high perceptual quality for human eyes. The domain-adaptive codebook is learned based on a set of training faces for the current task domain, e.g., for face recognition in surveillance videos using low-quality web cameras. The domain-adaptive codebook-based feature provides additional fidelity cues tuned to the current task domain.

Finally, the task-adaptive branch 603 computes task-adaptive features

$${Z}_{j , lq}^{i}$$

using a Low-Quality (LQ) low-bitrate face input that is usually downsized from the original input and then compressed aggressively by LIC or off-the-self VVC/HEVC compression scheme. This LQ feature is combined with the HQ generic codebook-based feature

$${\hat{Z}}_{j , g}^{i}$$

and optionally with the domain-adaptive codebook-based feature

$${\hat{Z}}_{j , d}^{i}$$

for final restoration. In other words, the proposed framework always restores an output face, which is fed into the end-task module to perform computer vision tasks, e.g., to be viewed by human or analyzed by machine.

Compared to prior video coding for machine consumption workflows described with FIGS. 5a&5b, the proposed framework advantageously has the flexibility of accommodating different domains and different computer vision tasks by using the LQ feature to tailor the restored face towards different tasks' needs. For example, for video conferencing, the LQ feature can provide additional fidelity details to restore a face more faithful to the current facial shape and expression. In another example, for face recognition, the LQ feature can provide additional discriminative cues to preserve the identity of the current person. The LQ feature also provides flexibility to balance the bitrate and the desired task quality. For ultra-low bitrate, the system relies more on codebook-based features by assigning a lower weight to the LQ feature. With higher bitrate, a better LQ feature can be obtained, and a larger weight gives better task quality.

In addition, at least one embodiment further relates to an online adaptive learning method to adjust, at test time, the LQ input and combining weights for the domain-adaptive branch and the task-adaptive branch, on the encoder side. Since video compression is a learning task with Ground-Truth (GT) target in the test stage, adjusting the network input and the combining weights online enables effective adaptation through direct Stochastic Gradient Decent (SGD) for better reconstruction tuned to each data for each specific task's need, without any overhead in transmission or decoding computation.

As shown in FIG. 6, first, in the Generic Branch 601, the system is given the input frame

$${X}_{j}^{i}$$

of size

$${h}_{j , in}^{i} \times {w}_{j , in}^{i} \times {k}_{i n} where {h}_{j , in}^{i} , {w}_{j , in}^{i}$$

and kᵢₙ are the height, width, and the number of channels, respectively. For example, kᵢₙ=3 for RGB color image, kᵢₙ=1 for grey image, kᵢₙ=4 for a RGB color image plus Depth image, etc. A Generic Embedding module 610 computes a generic embedded feature

$${Z}_{j , g}^{i}$$

of size

$${h}_{j g}^{i} \times {w}_{j g}^{i} \times {k}_{g} .$$

The Generic Embedding module 610 typically is a Neural Network (NN) consisting of several computational layers such as convolution (non-)linear activation, normalization, attention, skip connection, resizing, etc. The height

$${h}_{j g}^{i}$$

and width

$${w}_{jg}^{i}$$

of the generic embedded feature

$${Z}_{j , g}^{i}$$

depends on the size of input image as well as the network structure of the Generic Embedding module 610, and the number of feature channels k_{g} depends on the network structure of the Generic Embedding module 610. The encoder is provided with a learnable generic codebook 611 [symbol] _{g}={c_{g1}, . . . , c_{gm}_{_{g}}} containing m_{g} codewords. Each codeword c_{gl} is represented as a k_{g} dimensional feature vector. Then a Generic Code Generation module 612 computes a generic codebook-based representation

$${Y}_{j , gc}^{i}$$

based on the generic embedded feature

$${Z}_{j , g}^{i}$$

and the generic codebook [symbol] _{g}. Specifically, each element

$${z}_{j , g}^{i} ( u , v ) in {Z}_{j , q}^{i} \{ u = 1 , … , {h}_{j g}^{i} , v = 1 , … , {w}_{jg}^{i} )$$

is also a k_{g} dimensional feature vector, which is mapped to an optimal codeword c_{gidx(u,v)}(u, v) closest to

$${z}_{j , g}^{i} ( u , v ) :$$

$$i d x ( u , v ) = arg {min}_{l = 1}^{{m}_{g}} D ( {z}_{j , g}^{i} ( u , v ) , {c}_{gl} ) , \qquad ( 1 )$$

where

$$D ( {z}_{j , g}^{i} ( u , v ) , {c}_{g l} )$$

is the distance between

$${z}_{j , g}^{i} ( u , v )$$

and c_{gl} (e.g., L2 distance). That is,

$${z}_{j , g}^{i} ( u , v )$$

can be approximated by the codeword index idx(u, v), and the generic embedded feature Z

$${Z}_{j , g}^{i}$$

can be represented by the approximate integer generic codebook-based representation

$${Y}_{j , gc}^{i}$$

comprising

$${h}_{j g}^{i} \times {w}_{j g}^{i}$$

codeword indices. This integer generic codebook-based representation

$${Y}_{j , gc}^{i}$$

consumes few bits compared to the original

$${X}_{j}^{i}$$

to transfer.

Similarly, in the Domain-Adaptive Branch 602, a Domain-Adaptive Embedding module 630 computes a domain-adaptive embedded feature

$${Z}_{j , d}^{i}$$

of size

$${h}_{j d}^{i} \times {w}_{j d}^{i} \times {k}_{d}$$

based on the input

$${X}_{j}^{i} .$$

The Domain-Adaptive Embedding module 630 typically is a NN consisting of several computational layers such as convolution, (non-)linear activation, normalization, attention, skip connection, resizing, etc. The height

$${h}_{j d}^{i}$$

and width

$${w}_{j d}^{i}$$

of the domain-adaptive embedded feature

$${Z}_{j , d}^{i}$$

depends on the size of input image as well as the network structure of the Domain-Adaptive Embedding module 630, and the number of feature channels k_{d} depends on the network structure of the Domain-Adaptive Embedding module. The encoder is also provided with a learnable domain-adaptive codebook 631 [symbol] _{d}={c_{d1}, . . . , c_{dm}_{_{d}}} containing m_{d} codewords. Each codeword c_{dl} is represented as a k_{d} dimensional feature vector. Then a Domain-Adaptive Code Generation module 632 computes a domain-adaptive codebook-based representation

$${Y}_{j , dc}^{i}$$

on the domain-adaptive embedded feature

$${Z}_{j , d}^{i}$$

and the domain-adaptive codebook [symbol] _{d}. Specifically, each element

$${z}_{j , d}^{i} ( u , v ) in {Z}_{j , d}^{i} ( u = 1 , … , {h}_{jd}^{i} , v = 1 , … , {w}_{jd}^{i} )$$

is also a k_{d} dimensional feature vector, which is mapped to an optimal codeword c_{didx(u,v)}(u, v) closest to

$${z}_{j , d}^{i} ( u , v ) :$$

$$i dx ( u , v ) = arg {min}_{l = 1}^{{m}_{d}} D ( {z}_{j , d}^{i} ( u , v ) , {c}_{dl} ) , \qquad ( 1 )$$

where

$$D ( {z}_{j , d}^{i} ( u , v ) , {c}_{d l} )$$

is the distance between

$${z}_{j , d}^{i} ( u , v )$$

and c_{dl} (e.g., L2 distance). That is,

$${z}_{j , d}^{i} ( u , v )$$

can be approximated by the codeword index idx(u, v), and the domain-adaptive embedded feature

$${Z}_{j , d}^{i}$$

can be represented by the approximate integer domain-adaptive codebook-based representation

$${Y}_{j , dc}^{i}$$

comprising

$${h}_{j d}^{i} \times {w}_{j d}^{i}$$

codeword indices. This integer domain-adaptive codebook-based representation

$${Y}_{j , dc}^{i}$$

also consumes few bits compared to the original

$${X}_{j}^{i}$$

to transfer.

In the Task-Adaptive Branch 603, the input

$${X}_{j}^{i}$$

is downsampled by a scale of s (e.g., 4 times along both height and width) in a Downsampling module 650 to obtain a low-quality image/input (also simply referred to “low-quality” or LQ in the present application)

$${X}_{j , lq}^{i}$$

of size

$$\frac{{h}_{j , in}^{i}}{s} \times \frac{{w}_{j , in}^{i}}{s} \times {k}_{i n} .$$

For example, a bicubic/bilinear filter can be used to perform downsampling, however the present aspects do not put any constraint on the downsampling method. Then the low-quality

$${X}_{j , lq}^{i}$$

is aggressively compressed by an Encoding module 652 to compute a low-quality latent representation

$${Y}_{j , lq}^{i}$$

for transmission. The Encoding module 652 can use various methods to compress the low-quality

$${X}_{j , lq}^{i} .$$

For example, an NN-based LIC method may be used. In another variant, a traditional video coding tool like HEVC/VVC may also be used. In an embodiment, the compression rate is high so that the low-quality LQ latent representation

$${Y}_{j , lq}^{i}$$

consumes little bits. The present aspects do not put any restrictions on the specific method or the compression settings of the method used to compress the low-quality

$${X}_{j , lq}^{i} .$$

Finally, the generic codebook-based representation

$${Y}_{j , gc}^{i} ,$$

the domain-adaptive codebook-based representation

$${Y}_{j , dc}^{i} ,$$

and the low-quality latent representation

$${Y}_{j , lq}^{i}$$

together form the latent representation

$${Y}_{j}^{i}$$

as represented in FIG. 4, which is transmitted to the decoder. According to a variant embodiment, at the same time, domain-adaptive combining weights

$${W}_{j , dc}^{i}$$

(associated with

$${Y}_{j , dc}^{i} )$$

and LQ combining weights

$${W}_{j , lq}^{i}$$

(associated with

$${Y}_{j , lq}^{i}$$

may also be sent to the decoder, which will be used to guide the decoding process.

On the decoder side, first, in the Generic Branch 601, after receiving the generic codebook-based representation

$${Y}_{j , gc}^{i} ,$$

a Generic Feature Retrieval module 616 retrieves the corresponding codeword c_{didx(u,v)}(u, v) for each index idx(u, v) to form the decoded embedding feature

$${\hat{Z}}_{j , g}^{i}$$

of size

$${h}_{j g}^{i} \times {w}_{j g}^{i} \times {k}_{g} ,$$

based on the same codebook [symbol] _{g}={c_{g1}, . . . , c_{gm}_{_{g}}} as in the encoder. Similar to the generic branch, in the Domain-Adaptive Branch 602, after receiving the domain-adaptive codebook-based representation

$${Y}_{j , dc}^{i} ,$$

a Domain-Adaptive Feature Retrieval module 636 retrieves the corresponding codeword c_{didx(u,v)}(u,v) for each index idx(u, v) to form the decoded embedding feature

$${\hat{Z}}_{j , d}^{i}$$

of size

$${h}_{j d}^{i} \times {w}_{jd}^{i} \times {k}_{d} ,$$

based on the same codebook [symbol] ={c_{d1}, . . . , c_{dm}_{_{d}}} as in the encoder. In the task-adaptive branch 603, after receiving the low-quality latent representation

$${Y}_{j , lq}^{i} ,$$

a Decoding module 656 decodes a decoded low-quality input

$${\hat{X}}_{j , lq}^{i}$$

using a decoding method corresponding to the encoding method used in the Encoding module 652. For example, an NN-based LIC method may be used. In a variant, any conventional image or video codecs such as HEVC, VVC, etc., may be used. Then an LQ Embedding module 658 computes a low-quality embedding feature

$${Z}_{j , lq}^{i}$$

of size

$${h}_{j l q}^{i} \times {w}_{j l q}^{i} \times {k}_{l q}$$

based on the decoded low-quality input

$${\hat{X}}_{j , lq}^{i} .$$

The LQ Embedding network 658 is similar to the Embedding module in the encoder, which typically is an NN including layers like convolution, non-linear activation, normalization, attention, skip connection, resizing, etc. This invention does not put any restrictions on the network architectures of the LQ Embedding module.

Given the decoded generic embedding feature

$${\hat{Z}}_{j , g}^{i} ,$$

the decoded domain-adaptive embedding feature

$${\hat{Z}}_{j , d}^{i} ,$$

and the low-quality embedding feature

$${Z}_{j , lq}^{i} ,$$

as well as the domain-adaptive combining weights

$${W}_{j , dc}^{i}$$

and the LQ combining weights

$${W}_{j , lq}^{i}$$

received from the encoder, a Reconstruction module 618 computes the reconstructed output

$${\hat{X}}_{j}^{i} .$$

In a variant embodiment, the Reconstruction module 618 may consist of several computational layers such as convolution, (non-)linear activation, normalization, attention, skip connection, resizing, etc. There are multiple ways to combine the decoded generic embedding feature

$${\hat{Z}}_{i , g}^{i} ,$$

the decoded domain-adaptive embedding feature

$${\hat{Z}}_{j , d}^{i} ,$$

and the low-quality embedding feature

$${Z}_{j , lq}^{i} .$$

According to a variant,

$${\hat{Z}}_{j , g}^{i} ,$$

$${\hat{Z}}_{j , d}^{i} , and {Z}_{j , lq}^{i}$$

may be designed to have the same width

$${w}_{j}^{i}$$

and height

$${h}_{j}^{i}$$

by designing the structure of the Generic Embedding module 610, the Domain-Adaptive Embedding module 620, and the LQ Embedding module 658. According to another variant, the decoded features

$${\hat{Z}}_{i , g}^{i} , {\hat{Z}}_{j , d}^{i} , and {Z}_{j , lq}^{i}$$

may be resized to have the same width

$${w}_{j}^{i}$$

and height

$${h}_{j}^{i}$$

through further convolution layers. Then

$${\hat{Z}}_{i , g}^{i} , {\hat{Z}}_{j , d}^{i} , {Z}_{j , lq}^{i}$$

having a same two-dimensional dimension may be combined through concatenation, modulation, etc. According to a particular embodiment, different weights may be used in the combination. In a variant, the domain-adaptive combining weights

$${W}_{j , dc}^{i}$$

determines how important the decoded domain-adaptive codebook-based feature

$${\hat{Z}}_{j , d}^{i}$$

is when combined
with the decoded generic codebook-based feature

$${\hat{Z}}_{j , g}^{i} .$$

In another variant, the LQ combining weights

$${W}_{j , lq}^{i}$$

determines how important the low-quality embedding feature

$${Z}_{j , lq}^{i}$$

is when combined with the decoded generic codebook-based feature

$${\hat{Z}}_{j , g}^{i}$$

and the decoded domain-adaptive codebook-based feature

$${\hat{Z}}_{j , d}^{i} .$$

The present aspects do not put any restrictions on the network architectures of the Reconstruction module 618 or the way to combine

$${\hat{Z}}_{i , g}^{i} , {\hat{Z}}_{j , d}^{i} , and {Z}_{j , lq}^{i} .$$

According to a particular feature, the domain-adaptive combining weights

$${W}_{j , dc}^{i}$$

and the LQ combining weights

$${W}_{j , lq}^{i}$$

are sent from the encoder to the decoder. The encoder can determine these weights in many ways. For example, the encoder can decide whether or not to compute the domain-adaptive embedding feature

$${Z}_{j , d}^{i}$$

and send the domain-adaptive codebook-based representation

$${Y}_{j , dc}^{i}$$

and the domain-adaptive combining weights

$${W}_{j , dc}^{i}$$

to decoder. Accordingly, in an embodiment, only the generic codebook-based representation

$${Y}_{j , gc}^{i}$$

and the low-quality latent representation

$${Y}_{j , lq}^{i}$$

together form the latent representation

$${Y}_{j}^{i}$$

of FIG. 4, which is transmitted to the decoder. Correspondingly, the Reconstruction module 618 will decide whether to use the decoded domain-adaptive codebook-based embedding feature

$${\hat{Z}}_{j , d}^{i}$$

to compute the restored face. Also, the encoder can decide whether or not to compute the low-quality latent representation

$${Y}_{j , lq}^{i}$$

in the Task-Adaptive Branch 603 and the LQ combining weights

$${W}_{j , lq}^{i}$$

and transmit them to decoder. Accordingly, in this embodiment, only the generic codebook-based representation

$${Y}_{j , gc}^{i}$$

and the decoded domain-adaptive embedding feature

$${\hat{Z}}_{j , d}^{i}$$

together form the latent representation

$${Y}_{j}^{i}$$

of FIG. 4, which is transmitted to the decoder. Correspondingly the decoder will decide whether to compute the low-quality embedding feature

$${Z}_{j , lq}^{i}$$

and use it in the Reconstruction module to compute the restored face.

In one embodiment, the best performing

$${W}_{j , dc}^{i} and / or {W}_{j , lq}^{i}$$

may be selected from a set of preset weight configurations based on a target performance metric (e.g., the Rate-Distortion tradeoff and/or the task performance metric like recognition accuracy). Also, in another embodiment,

$${W}_{j , dc}^{i} and / or {W}_{j , lq}^{i}$$

may be selected for each video frame individually, or the system may determine

$${W}_{j , dc}^{i} and / or {W}_{j , lq}^{i}$$

based on part of the video frames (e.g., the first frames of the video conferencing session) based on the averaged performance metric of these frames, and then fix the selected weights for the rest frames.

The skilled in the art will appreciate that the domain-adaptive combining weights

$${W}_{j , dc}^{i}$$

and the LQ combining weights

$${W}_{j , lq}^{i}$$

usually comprise one or multiple floating point numbers,

$${W}_{j , dc}^{i} = {w}_{j , dc , 1}^{i} , … , {w}_{j , dc , N}^{i} and {W}_{j , lq}^{i} = {w}_{j , lq , 1}^{i} , … , {w}_{j , lq , N}^{i} .$$

The number N is determined by the structure of the Reconstruction module 618 based on how the decoded domain-adaptive codebook-based embedding feature

$${\hat{Z}}_{j , d}^{i}$$

is combined with the decoded generic codebook-based embedding feature

$${\hat{Z}}_{j , g}^{i}$$

or how the low-quality embedding feature

$${Z}_{j , lq}^{i}$$

is combined with the decoded domain-adaptive codebook-based embedding feature

$${\hat{Z}}_{j , d}^{i}$$

and the decoded generic codebook-based embedding feature

$${\hat{Z}}_{i , g}^{i} .$$

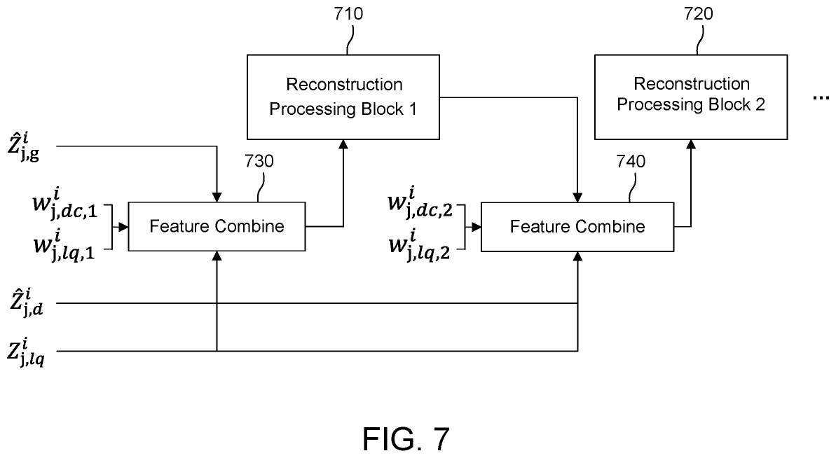

According to at least one embodiment, the reconstruction module performs a weighted combination of the reconstructed generic codebook-based feature, the reconstructed domain-adaptive codebook-based feature, and of the low-quality feature. FIG. 7 illustrates a workflow of the reconstruction module according to an embodiment. The embodiment of the Reconstruction module of FIG. 7 may be implemented in the Reconstruction module 618 of FIG. 6. In the embodiment of the Reconstruction module of FIG. 7,

$${\hat{Z}}_{j , g}^{i} , {\hat{Z}}_{j , d}^{i} and {Z}_{j , lq}^{i}$$

are combined before each Reconstruction Processing Block 710, 720 (e.g., comprising of a set of convolutional, activation, or other type of layers). Each time they are combined, e.g., before the Reconstruction Processing Block l (with l=1 or 2 on FIG. 7), the weight

$${w}_{j , dc , l}^{i}$$

is used to combine

$${\hat{Z}}_{j , g}^{i} and {\hat{Z}}_{j , d}^{i} ,$$

and the weight

$${w}_{j , lq , l}^{i}$$

is used to combine

$${\hat{Z}}_{j , g}^{i} , {\hat{Z}}_{j , d}^{i} and {Z}_{j , lq}^{i} ,$$

in a Feature Combine module 730, 740.

According to at least one embodiment, an online adaptive learning method is further disclosed to automatically determine the domain-adaptive combining weights

$${W}_{j , dc}^{i}$$

and/or the LQ combining weights

$${W}_{j , lq}^{i} .$$

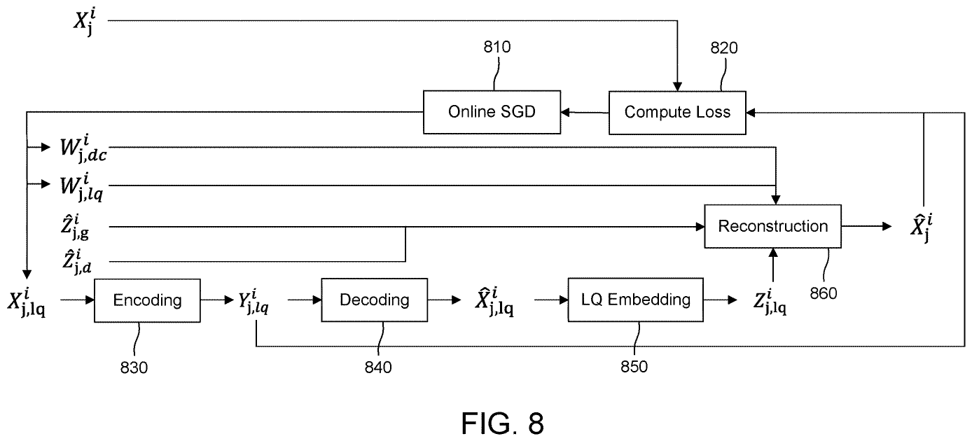

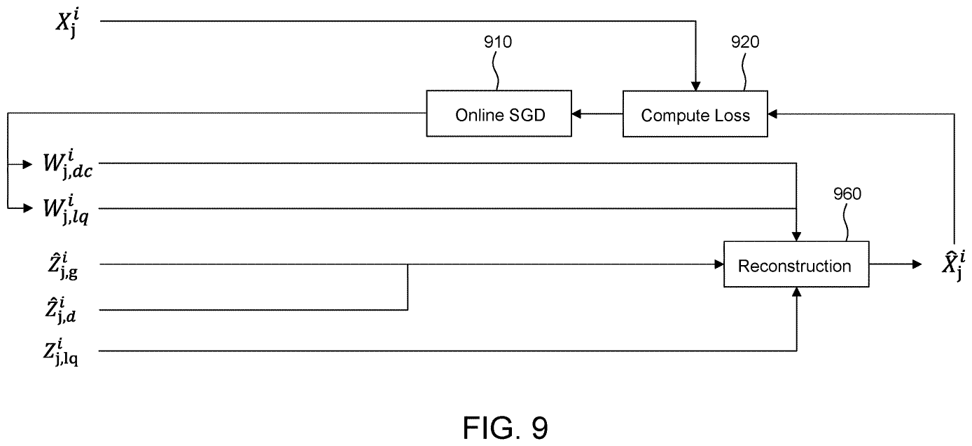

FIG. 8 and FIG. 9 illustrate a workflow of an online adaptive learning according to various embodiments. Advantageously, these embodiments provide additional flexibility for improving the video compression performance according to the target needs on the fly. The proposed online adaptive learning mechanism tunes

$${W}_{j , d c}^{i} and / or {W}_{j , lq}^{i} ,$$

and optionally the low-quality

$${X}_{j , lq}^{i}$$

during the inference process according to a target online loss. The online adaptive learning happens on the encoder side, which sends the online tuned weights

$${W}_{j , dc}^{i} and / or {W}_{j , lq}^{i}$$

to the decoder. The decoding process may stay the same as in FIG. 4 and FIG. 5, since the determination of the weight

$${W}_{j , dc}^{i} and / or {W}_{j , lq}^{i}$$

in the encoder does not change the processing pipeline in decoder. FIG. 8 illustrates a workflow of an online adaptive learning according to a first embodiment wherein both the domain-adaptive combining weights

$${W}_{j , dc}^{i}$$

and/or the LQ combining weights

$${W}_{j , lq}^{i} ,$$

and the low-quality

$${X}_{j , lq}^{i}$$

are tuned. FIG. 9 illustrates a workflow of an online adaptive learning according to a second embodiment wherein only the domain-adaptive combining weights

$${W}_{j , dc}^{i}$$

and/or the LQ combining weights

$${W}_{j , lq}^{i}$$

are tuned.

Specifically, in the first embodiment of FIG. 8, during online adaptive learning, the system first performs the encoding and decoding processes described with the exemplary embodiments of FIG. 4 and FIG. 7. In these embodiments, based on the input

$${X}_{j}^{i} ,$$

the initial domain-adaptive combining weights

$${W}_{j , lq}^{i} ,$$

and the initial LQ combining weights

$${W}_{j , dc}^{i} ,$$

the encoding/decoding processes generate the decoded generic embedding feature

$${\hat{Z}}_{i , g}^{i} ,$$

the decoded domain-adaptive embedding feature

$${\hat{Z}}_{j , d}^{i} ,$$

the low-quality image

$${X}_{j , lq}^{i} ,$$

the low-quality latent representation

$${Y}_{j , lq}^{i} ,$$

and the reconstructed output

$${\hat{X}}_{j}^{i} .$$

The encoding/decoding processes keep the decoded generic embedding feature

$${\hat{Z}}_{i , g}^{i}$$

and the decoded domain-adaptive embedding feature

$${\hat{Z}}_{j , d}^{i}$$

unchanged. Then a Compute Loss module 820 computes an online loss

$$L ( {X}_{j}^{i} , {\hat{X}}_{j}^{i} , {Y}_{j , lq}^{i} )$$

based on the reconstructed output

$${\hat{X}}_{j}^{i} ,$$

the original input

$${X}_{j}^{i} ,$$

and the low-quality latent representation

$${Y}_{j , lq}^{i} .$$

The online loss can be flexibly configured to pursue different compression targets. For example, for improved human consumption, the Rate-Distortion tradeoff loss can be used:

$$L ( {X}_{j}^{i} , {\hat{X}}_{j}^{i} , {Y}_{j , lq}^{i} ) = D ( {X}_{j}^{i} , {\hat{X}}_{j}^{i} ) + λ R ( {Y}_{j , lq}^{i} ) \qquad ( 2 )$$

Where

$$D ( {X}_{j}^{i} , {\hat{X}}_{j}^{i} )$$

measures the distortion between

$${\hat{X}}_{j}^{i} and {X}_{j}^{i}$$

(e.g., the MSE, SSIM, the perceptual loss like LIPIPS, or a weighted combination of these losses).

$$R ( {Y}_{j , lq}^{i} )$$

is the rate loss measuring the bit consumption of the low-quality latent representation

$${Y}_{j , lq}^{i}$$

(e.g., the entropy likelihood estimated by an end-to-end Learned Image Coding). On the other hand, for improved machine consumption, the task loss can be used with the Rate-Distortion tradeoff loss:

$$L ( {X}_{j}^{i} , {\hat{X}}_{j}^{i} , {Y}_{j , l q}^{i} ) = γ ℱ ( {X}_{j}^{i} , {\hat{X}}_{j}^{i} ) + D ( {X}_{j}^{i} , {\hat{X}}_{j}^{i} ) + λR ( {Y}_{j , lq}^{i} ) \qquad ( 3 )$$

Where

$$ℱ ( {\hat{X}}_{j}^{i} )$$

measures the loss of performing the end computer vision task over the reconstructed output

$${\hat{X}}_{j}^{i} ,$$

e.g., face recognition error loss, the distortion between the facial embedded feature computed from the original

$${X}_{j}^{i}$$

and the reconstructed

$${\hat{X}}_{j}^{i} ,$$

etc. This online loss is differentiable and an Online SGD module 810 computes the gradient

$$\frac{\partial L ( {X}_{j}^{i} , {\hat{X}}_{j}^{i} , {Y}_{j , lq}^{i} )}{\partial {W}_{j , dc}^{i}}$$

of the online loss

$$L ( {X}_{j}^{i} , {\hat{X}}_{j}^{i} , {Y}_{j , lq}^{i} )$$

against the weight

$${W}_{j , dc}^{i} ,$$

the gradient

$$\frac{\partial L ( {X}_{j}^{i} , {\hat{X}}_{j}^{i} , {Y}_{j , lq}^{i} )}{\partial {W}_{j , lq}^{i}}$$

of the online loss

$$L ( {X}_{j}^{i} , {\hat{X}}_{j}^{i} , {Y}_{j , lq}^{i} )$$

against the weight

$${W}_{j , lq}^{i} ,$$

and the gradient

$$\frac{\partial L ( {X}_{j}^{i} , {\hat{X}}_{j}^{i} , {Y}_{j , lq}^{i} )}{\partial {X}_{j , lq}^{i}}$$

of the online loss

$$L ( {X}_{j}^{i} , {\hat{X}}_{j}^{i} , {Y}_{j , lq}^{i} )$$

against the low-quality

$${X}_{j , lq}^{i} ,$$

which are backpropagated to update weight

$${W}_{j , dc}^{i} and / or {W}_{j , lq}^{i} ,$$

and the low-quality

$${X}_{j , lq}^{i} :$$

$${W}_{j , dc}^{i} ( t ) = {W}_{j , d c}^{i} ( t - 1 ) - α \frac{\partial L ( {X}_{j}^{i} , {\hat{X}}_{j}^{i} , {Y}_{j , lq}^{i} )}{\partial {W}_{j , dc}^{i}}$$

$${W}_{j , lq}^{i} ( t ) = {W}_{j , lq}^{i} ( t - 1 ) - β \frac{\partial L ( {X}_{j}^{i} , {\hat{X}}_{j}^{i} , {Y}_{j , lq}^{i} )}{\partial {W}_{j , lq}^{i}}$$

$${X}_{j , lq}^{i} ( t ) = {X}_{j , lq}^{i} ( t - 1 ) - δ \frac{\partial L ( {X}_{j}^{i} , {\hat{X}}_{j}^{i} , {Y}_{j , lq}^{i} )}{\partial {X}_{j , lq}^{i}}$$

Where t is the index of the current iteration, and t=1, . . . , T if T iterations are taken in total. α, β, and δ are step sizes for online adaptation, which can be empirically preset as hyperparameters, or determined on the fly by searching through a few different settings, similar to the initial weight

$${W}_{j , d c}^{i} ( 0 ) , {W}_{j , lq}^{i} ( 0 ) .$$

The present aspects do not put any restrictions on how to set the hyperparameters.

Finally, after T iterations of online updates, the updated

$${X}_{j , lq}^{i} ( t )$$

is used to recompute the low-quality latent representation

$${Y}_{j , lq}^{i} ,$$

which is sent to the decoder together with the updated

$${W}_{j , dc}^{i} ( T ) ,$$

the updated

$${W}_{j , lq}^{i} ( T ) ,$$

as well as the generic codebook-based representation

$${Y}_{j , gc}^{i}$$

and the domain-adaptive codebook-based representation

$${Y}_{j , dc}^{i}$$

described with FIG. 4.

The skilled in the art will notice that to make the online loss differentiable against the low-quality input

$${X}_{j , lq}^{i}$$

so that the gradient

$$\frac{\partial L ( {X}_{j}^{i} , {\hat{X}}_{j}^{i} , {Y}_{j , lq}^{i} )}{\partial {X}_{j , lq}^{i}}$$

can be computed, the method used by the Encoding and Decoding modules 830, 840 for compressing the low-quality input

$${X}_{j , lq}^{i}$$

in FIG. 8 is an NN-based LIC method. In comparison, FIG. 9 describes a second embodiment of the online adaptive learning workflow where only the domain-adaptive combining weights

$${W}_{j , dc}^{i}$$

and the LQ combining weights

$${W}_{j , lq}^{i}$$

are tuned. In this scenario, the Encoding and Decoding modules can use non-differentiable video codecs such as HEVC/VVC. Similar to the first embodiment of FIG. 8, during the online adaptive learning of the second embodiment illustrated in FIG. 9, the system first performs the encoding and decoding processes as presented in FIG. 4 and FIG. 7, based on the input

$${X}_{j}^{i}$$

and the initial domain-adaptive combining weights

$${W}_{j , dc}^{i}$$

and the initial LQ combining weights

$${W}_{j , lq}^{i} ,$$

to obtain the decoded generic embedding feature

$${\hat{Z}}_{j , g}^{i} ,$$

the decoded domain-adaptive embedding feature

$${\hat{Z}}_{j , d}^{i} ,$$

and the low-quality embedding feature

$${Z}_{j , lq}^{i} ,$$

and the reconstructed output

$${\hat{X}}_{j}^{i} .$$

The system keeps the decoded generic embedding feature

$${\hat{Z}}_{j , g}^{i} ,$$

the decoded domain-adaptive embedding feature

$${\hat{Z}}_{j , d}^{i} ,$$

and the low-quality embedding feature

$${Z}_{j , lq}^{i}$$

unchanged. Then a Compute Loss module 920 computes an online loss

$$L ( {X}_{j}^{i} , {\hat{X}}_{j}^{i} )$$

based on the reconstructed output

$${\hat{X}}_{j}^{i}$$

and the original input

$${X}_{j}^{i} .$$

For example,

$$L ( {X}_{j}^{i} , {\hat{X}}_{j}^{i} )$$

measures the distortion between

$${\hat{X}}_{j}^{i} and {X}_{j}^{i}$$

(e.g., the MSE, SSIM, the perceptual loss like LIPIPS, or a weighted combination of these losses) to improve compression performance for human consumption. For improved compression aiming at machine consumption,

$$L ( {X}_{j}^{i} , {\hat{X}}_{j}^{i} )$$

measures the distortion between

$${\hat{X}}_{j}^{i} and {X}_{j}^{i}$$

and the task performance loss at the same time, e.g., face recognition error loss, the distortion between facial embedded feature computed from the original

$${X}_{j}^{i}$$

and reconstructed

$${\hat{X}}_{j}^{i}$$

using a neural network as known in the art, etc. This online loss is differentiable and an Online SGD module 910 computes the gradient

$$\frac{\partial L ( {X}_{j}^{i} {\hat{X}}_{j}^{t} )}{\partial {W}_{j , dc}^{i}}$$

of the online loss

$$L ( {X}_{j}^{i} , {\hat{X}}_{j}^{i} )$$

against the weight

$${W}_{j , dc}^{i}$$

and the gradient

$$\frac{\partial L ( {X}_{j}^{i} {\hat{X}}_{j}^{t} )}{\partial {W}_{j , lq}^{i}}$$

of the online loss

$$L ( {X}_{j}^{i} , {\hat{X}}_{j}^{i} )$$

against the weights

$${W}_{j , lq}^{i} ,$$

which are backpropagated to update the combining weights:

$${W}_{j , dc}^{i} ( t ) = {W}_{j , dc}^{i} ( t - 1 ) - α \frac{\partial L ( {X}_{j}^{i} {\hat{X}}_{j}^{i} )}{\partial {W}_{j , dc}^{i}}$$

$${W}_{j , lq}^{i} ( t ) = {W}_{j , lq}^{i} ( t - 1 ) - β \frac{\partial L ( {X}_{j}^{i} {\hat{X}}_{j}^{i} )}{\partial {W}_{j , lq}^{i}}$$

Where t is the index of the current iteration, and t=1, . . . , T if T iterations are taken in total. α and β are the step sizes for online adaptation, which can be empirically preset as hyperparameters, or determined on the fly by searching through a few different settings, similar to the initial combining weights

$${W}_{j , dc}^{i} ( 0 ) and {W}_{j , lq}^{i} ( 0 ) .$$

The present aspects do not put any restrict on how to set the hyperparameters. Finally, after T iterations of online updates, in FIG. 9, the updated

$${W}_{j , dc}^{i} ( T )$$

and the updated

$${W}_{j , lq}^{i} ( T )$$

are sent to the decoder together with the low-quality latent representation

$${Y}_{j , lq}^{i} ,$$

as well as the generic codebook-based representation

$${Y}_{j , gc}^{i}$$

and the domain-adaptive codebook-based representation

$${Y}_{j , dc}^{i}$$

described in FIG. 6.

As mentioned before, in some embodiments, the encoder can choose to skip the entire Domain-Adaptive Branch and/or the Task-Adaptive Branch, where the corresponding domain-adaptive combining weights

$${W}_{j , dc}^{i}$$

is set as

$${W}_{j , dc}^{i} = 0$$

and/or the corresponding LQ combining weights

$${W}_{j , lq}^{i}$$

is set as

$${W}_{j , lq}^{i} = 0 ,$$

and the Reconstruction module 860, 960 simply reconstructs the output

$${\hat{X}}_{j}^{i}$$

based on the remaining decoded generic embedding feature

$${\hat{Z}}_{j , g}^{i} ,$$

the decoded domain-adaptive embedding feature

$${\hat{Z}}_{j , d}^{i} if {W}_{j , dc}^{i} > 0 ,$$

and the low-quality embedding feature

$${Z}_{j , lq}^{i} if {W}_{j , lq}^{i} > 0 .$$

According to another embodiment, a training process is further disclosed. A training process learns the learnable generic codebook [symbol] ={c₁, . . . cₘ_{_{g}}}, the Generic Embedding network parameters, the domain-adaptive codebook [symbol] _{d}={c₁, . . . , cₘ_{_{d}}}, the Domain-Adaptive Embedding network parameters, and the Reconstruction network parameters. Also, when the Encoding module and the Decoding module use NN-based LIC, or the Downsampling module uses a NN-based method, the corresponding network parameters are also learned in the training process. In a variant embodiment, the different network modules are trained in several different stages. For example in the first stage, the learnable generic codebook [symbol] _{g}={c₁, . . . , cₘ_{_{g}})}, the Generic Embedding network parameters, and the Reconstruction network parameters from the Generic Branch are trained in an end-to-end fashion by using high-quality face inputs

$${X}_{j}^{i} ,$$

where the training target is to minimize the reconstruction distortion between the reconstructed output

$${\hat{X}}_{j}^{i}$$

and the input

$${X}_{j}^{i} .$$

Various distortion loss can be used, such as MSE, MSSSIM, perceptual LPIPS, etc., or a weighted combination of different losses. A Generative Adversarial Network (GAN) training strategy can be used to improve the learned codebook quality for visually pleasing reconstruction.

Then in the second stage, the generic codebook [symbol] _{g}={c₁, . . . , cₘ_{_{g}}} and the Generic Embedding network from the Generic Branch are kept unchanged, and the learnable domain adaptive codebook [symbol] _{d}={c₁, . . . , cₘ_{_{g}}} and the Domain Adaptive Embedding network parameters from the Domain-Adaptive Branch, as well as part of the Reconstruction network parameters from the Generic Branch are trained in an end-to-end fashion by using face inputs

$${X}_{j}^{i}$$

from the target domain (e.g., captured by low-quality web cameras). For example, in the embodiment of the Reconstruction module described in FIG. 7, the network parameters in the Reconstruction Processing Blocks 710, 720 are fixed, while the Feature Combining modules 730, 740 are trained in this stage. The training target is also to minimize the reconstruction distortion between the reconstructed output

$${\hat{X}}_{j}^{i}$$

and the input

$${X}_{j}^{i} ,$$

and various distortion losses can be used, such as MSE, MSSSIM, perceptual LPIPS, etc., or a weighted combination of different losses. Also, the Generative Adversarial Network (GAN) training strategy can be used to improve the learned codebook quality for visually pleasing reconstruction.

In the third stage, the generic codebook [symbol] _{g}={c₁, . . . , cₘ_{_{g}}} and the Generic Embedding network from the Generic Branch, the learnable domain adaptive codebook [symbol] _{d}={c₁, . . . , cₘ_{_{d}}} and the Domain Adaptive Embedding network from the Domain-Adaptive Branch are kept unchanged. The Encoding and Decoding module in the Task-Adaptive Branch as well as part of the Reconstruction network parameters from the Generic Branch are trained in an end-to-end fashion by using face inputs

$${X}_{j}^{i}$$

from the task domain (e.g., videos to apply the face recognition task). For example, a general image dataset with various image qualities can be used to train the Encoding and Decoding modules first, which can then be finetuned using the face inputs from the task domain. The training target is to minimize the Rate-Distortion tradeoff loss of the reconstructed output

$${\hat{X}}_{j}^{i}$$

and the rate loss of the latent representation

$${Y}_{j , lq}^{i}$$

similar to Equation (2). The training method used for an NN-based LIC method can be used here.

Then, in the final stage, all network parameters are kept unchanged, except for the LQ Embedding module 850 and part of the Reconstruction module 860. The unfixed parameters are trained by face inputs

$${X}_{j}^{i}$$

from the task domain in an end-to-end fashion. For example, in the embodiment of the Reconstruction module described by FIG. 7, the network parameters in the Reconstruction Processing Blocks 710, 720 are fixed, while the Feature Combining modules 730, 740 are trained in this stage. The training target is to minimize the joint loss of Equation (3), which consists of the task performance loss, and the Rate-Distortion loss.

In other embodiments, other training strategies can be taken. For example, in variant embodiment, other training stages can be used where in each stage different modules can be trained or finetuned based on different sets of losses, or the entire network can be trained end-to-end in one stage. The present aspects do not put any restrictions on the training process.

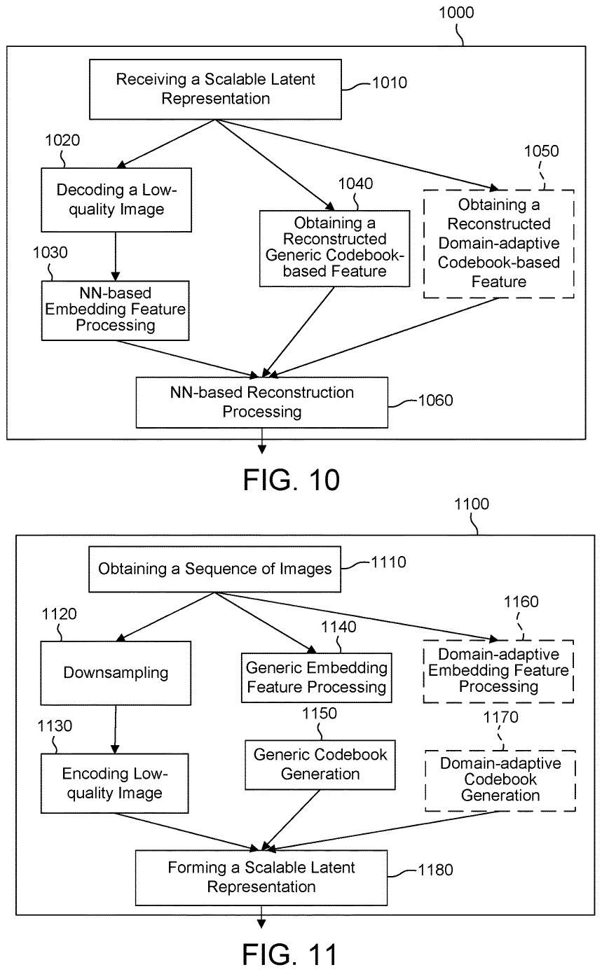

FIG. 10 illustrates a block diagram of a decoding method 1000 according to one embodiment. In a step 1010, a scalable latent representation associated with image data is received. The scalable latent representation comprises a generic codebook-based representation

$$( {Y}_{j , gc}^{i} )$$

and a low-quality latent representation

$$( {Y}_{j , lq}^{i} )$$

of a sequence of images. Optionally, The scalable latent representation comprises a domain-adaptive codebook-based representation

$$( {Y}_{j , dc}^{i} ) .$$

In a step 1020, the low-quality latent representation

$$( {Y}_{j , lq}^{i} )$$

is decoded and a reconstructed low-quality image

$$( {\hat{X}}_{j , lq}^{i} )$$

is obtained. In a step 1030, the reconstructed low-quality image

$$( {\hat{X}}_{i , lq}^{i} )$$

is fed to a neural network-based embedding feature processing to generate a low-quality feature

$$( {Z}_{j , lq}^{i} of size {h}_{jlq}^{i} \times {w}_{jlq}^{i} \times {k}_{l q} )$$

representative of a feature of image data samples. In parallel or in sequence, in a step 1040, a reconstructed generic codebook-based feature

$$( {\hat{Z}}_{j , g}^{I} of size {h}_{jg}^{i} \times {w}_{jg}^{i} \times {k}_{g} )$$

representative of image data samples is reconstructed from the generic codebook-based representation

$$( {Y}_{j , gc}^{i} )$$

using the generic codebook shared between the encoding and the decoding. Optionally, in a step 1050, a reconstructed domain-adaptive codebook-based feature

$$( {\hat{Z}}_{j , d}^{I} of size {h}_{jd}^{i} \times {w}_{jd}^{i} \times {k}_{d} )$$

representative of an appearance of image data samples is reconstructed from the domain-adaptive codebook-based representation

$$( {Y}_{j , d}^{i} )$$

using the domain-adaptive codebook shared between the encoding and the decoding. Finally in a step 1060, the reconstructed generic codebook-based feature

$$( {\hat{Z}}_{j , g}^{i} ) ,$$

the low-quality feature

$$( {Z}_{j , lq}^{i} )$$

and optionally the reconstructed domain-adaptive codebook-based feature

$$( {\hat{Z}}_{j , d}^{i} )$$

are fed to a neural network-based reconstruction processing to generate a reconstructed image

$$( {\hat{X}}_{j}^{i} )$$

adapted to a plurality of computer vision tasks including both machine consumption and human consumption. In a variant, the neural network-based reconstruction processing is further fed with domain-adaptive combining weights

$$( {W}_{j , dc}^{i} ) ,$$

associated with the domain-adaptive codebook-based representation

$$( {Y}_{j , dc}^{i} )$$

and that determines how important the reconstructed domain-adaptive codebook-based feature

$$( {\hat{Z}}_{j , d}^{i} )$$

is when combined with the reconstructed generic codebook-based feature

$$( {\hat{Z}}_{j , g}^{i} ) ,$$

and with low quality combining weights

$$( {W}_{j , lq}^{i} ) ,$$

associated with the low-quality latent representation

$$( {Y}_{j , lq}^{i} )$$

and that determines how important the low-quality feature

$$( {Z}_{j , lq}^{i} )$$

is when combined with the reconstructed generic codebook-based feature

$$( {\hat{Z}}_{j , g}^{i} )$$

and the reconstructed domain-adaptive codebook-based feature

$$( {\hat{Z}}_{j , d}^{i} ) .$$

FIG. 11 illustrates a block diagram of an encoding method 1100 according to one embodiment. In a step 1110, a sequence of images

$$( {X}_{j}^{i} )$$

to encode is received. In a step 1120, an image of the sequence of images is downsampled to obtain low-quality image

$$( {X}_{j , lq}^{i} ) .$$

In a step 1130, the low-quality image

$$( {X}_{j , lq}^{i} )$$

is encoded to obtain a low-quality latent representation

$$( {Y}_{j , lq}^{i} )$$

using any known encoding such as traditional codec HEVC/VVC or NN based LIC. In parallel or in sequence, in a step 1140, a neural network-based generic embedding feature processing is applied to sequence of images to generate a generic feature

$$\{ {Z}_{j , g}^{i} )$$

representative of a generic feature of image data samples. In a step 1150, the generic feature

$$( {Z}_{j , g}^{i} )$$

is encode using a generic codebook into a generic codebook-based representation

$$( {Y}_{j , gc}^{i} )$$

of the sequence of images, thus achieving a high compression rate. In optional steps, same process is performed for domain-adaptive feature: in a step 1160, a neural network-based domain-adaptive embedding feature processing is applied to sequence of images to generate a domain-adaptive feature

$$( {Z}_{j , d}^{i} )$$

representative of an appearance of image data samples. In a step 1170, the domain-adaptive feature

$$( {Z}_{j , d}^{i} )$$

is encoded using a domain-adaptive codebook into a domain-adaptive codebook-based representation

$$( {Y}_{j , dc}^{i} )$$

of the sequence of images, also achieving a high compression rate. Then in a step 1180, the generic codebook-based representation

$$( {Y}_{j , g c}^{i} ) ,$$

the low-quality latent representation

$$( {Y}_{j , lq}^{i} )$$

and optionally the domain-adaptive codebook-based representation

$$( {Y}_{j , dc}^{i} )$$

are associated to form a scalable latent representation

$$( {Y}_{j}^{i} )$$

of the sequence of images

$$( {X}_{j}^{i} )$$

adapted to a plurality of computer vision tasks including both machine consumption and human consumption. In a variant, domain-adaptive combining weights

$$( {W}_{j , dc}^{i} )$$

associated with the domain-adaptive codebook-based representation

$$( {Y}_{j , dc}^{i} )$$

and low-quality combining weights

$$( {W}_{j , lq}^{i} )$$

associated with the low-quality latent representation

$$( {Y}_{j , lq}^{i} )$$

are further determined for the discriminating reconstruction processing.

We describe a number of embodiments. Features of these embodiments can be provided alone or in any combination, across various claim categories and types. Further, embodiments can include one or more of the following features, devices, or aspects, alone or in any combination, across various claim categories and types as described below.

A novel human-centric video compression solution is disclosed that is based on robust face restoration that can be flexibly configured for both human consumption and machine consumption. The disclosed pipeline combines a generic branch, a domain-adaptive branch, and a task-adaptive branch for effective human-centric video compression. Advantageously, the generic branch ensures baseline high-quality face reconstruction using the highly efficient discrete generic codebook-based representation. The domain-adaptive branch provides domain-specific features to improve the reconstruction fidelity and expressiveness for the specific domain of data that the solution is applied to. The task-adaptive branch provides additional detailed visual cues for the particular data to compress by transmitting a low-quality low-bitrate version of the face input.

A flexible task-adaptive control is enabled that allows tuning the reconstructed output towards different tasks' needs. The high-quality generic codebook-based feature, the domain-adaptive codebook-based feature, and the low-quality feature from the task-adaptive branch are weighted combined where the combining weights can be tuned at test time to balance bitrate, reconstruction quality, and task performance. The combining weights can be manually set or automatically set.

A flexible online task-adaptive control is enabled that allows automatically adjusting the LQ face image and the corresponding combining weights for each video frame based on actual needs. This enables the novel feature of flexible online task-adaptive control where users can adjust the LQ face image and the combining weights according to different quality metrics, different task performance metrics, and different rate-distortion tradeoffs.

A scalable domain-adaptive compression is allowed by providing a latent representation combining the HQ generic codebook-based representation and the domain-adaptive codebook-based representation for domain-adaptive face reconstruction. Such embodiment (combining only 2 branches 601, 602 among 3 of FIG. 6) provides a scalable solution to apply to multiple different data domains. The generic codebook and the reconstruction processing blocks can be pre-trained based on a large amount of training data and kept unchanged to provide HQ baseline reconstruction, while the domain-adaptive branch can be plugin branch that is adaptively trained for each data domain. Compared to the traditional solution of training one-fits-all network for compressing all data from all different data domains (which is analogous to training a large generic codebook to fit all data domains), or the traditional solution of training one specific network for each data domain separately (which is analogous to training a domain-adaptive codebook for each data domain without using a generic codebook), the proposed solution provides better reconstruction performance with smaller overall codewords.

A scalable task-adaptive compression is allowed by providing a latent representation that combines a codebook-based representation for face reconstruction towards human consumption and a task-adaptive representation to tune the reconstruction towards tasks needs. This framework (combining only 2 branches 601, 603 among 3 of FIG. 6) is scalable to accommodate different types of tasks, and different task models, in comparison to the previous video coding for machine solutions where for each particular task or task model, a set of individual learnable parameters of the compression model needs to be learned. In the proposed framework, for a new task, only part of the task-adaptive branch may need to be learned, while the generic branch, the domain-adaptive branch and the majority of the task-adaptive branch may remain fixed. In addition, with the online adaptive learning mechanism, if the change of the task model or the change of a task target is small, the entire pipeline may stay fixed and online tuned weights can provide a descent result by itself.

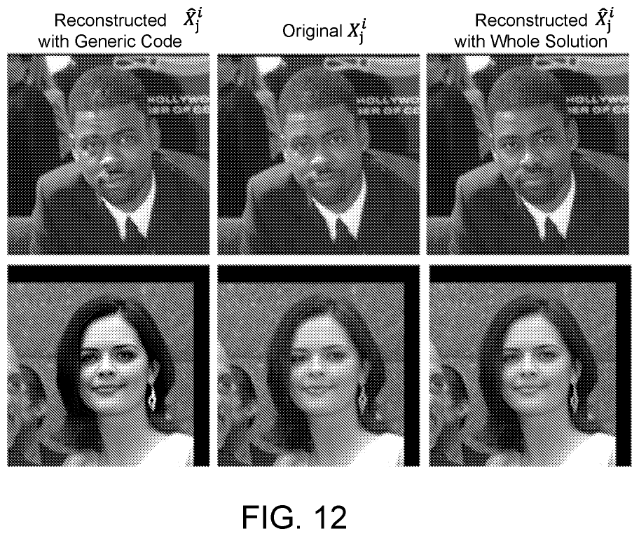

FIG. 12 shows two examples of an original and reconstructed image according to at least one embodiment. Because the learned high-quality codebook contains learned high-quality face priors, the reconstructed face can be even more visually pleasing than the original input as shown, for instance, in the bottom left photo of FIG. 12. Advantageously, the present aspects provide flexibility of task-adaptive control to accommodate various tasks' needs at the test time, scalable domain-adaptive and task-adaptive compression, a flexible framework of adopting various network architectures for individual network module components, a flexibility to accommodate various Encoding/Decoding methods in the adaptive branch, including both NN-based or traditional codecs.

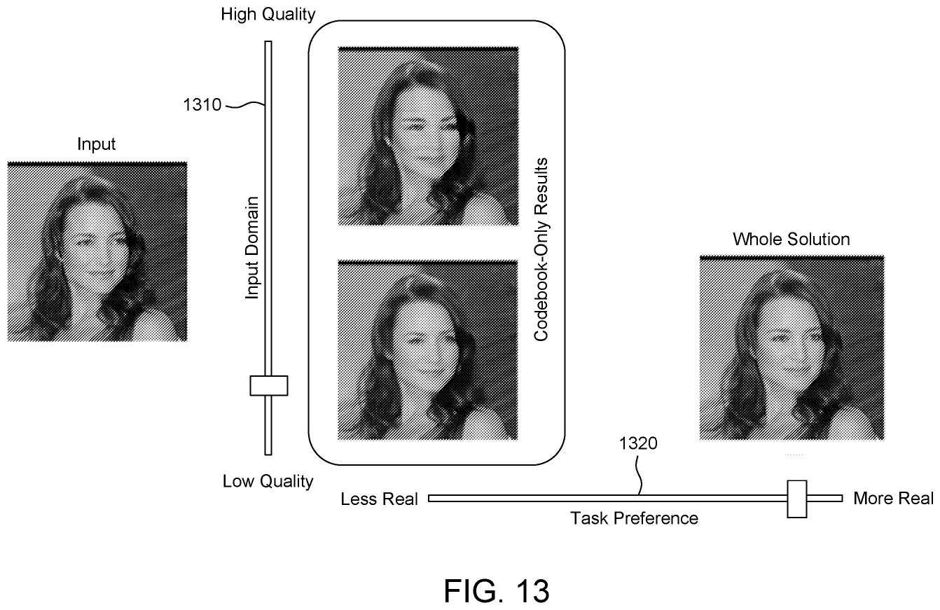

FIG. 13 shows an example of application to which aspects of the present embodiments may be applied. Human-centric video compression is essentially important in many applications, including applications for human consumption like video conferencing and applications for machine consumption like face recognition. Human-centric video compression has been one key focus in companies involving in cloud services and end devices. According to the application presented on FIG. 13, a device captures a face region and compresses it using at least one of the described embodiments. For example, a captured real input image can be shown in the sender's display device. Any type of quality controllable interface can control over some extent of bits to be used to code face or some extent of reality of to-be-delivered face at the receiver device. Quality controlling mechanism can vary. As a simple example, FIG. 13 shows a use case where a user can control along two dimensions over the quality of to-be-displayed face at the receiver's display device using human-interface panel on the device. The first dimension 1310 allows the user to control the degree the input/output face fits into the HQ generic codebook or the domain-adaptive codebook for the current domain. When the input face is not high-quality, generic codebook may generate unpleasant artifacts, which can be corrected by the domain-adaptive codebook. However, if the quality of the input face is too bad, the domain-adaptive codebook may be unreliable, and the HQ generic codebook can ensure basic reconstruction quality. This first dimension of control allows the user to tune reconstruction based on the quality of the current capture device. The second dimension 1320 allows the user to control how the low-quality input is compressed to balance bitrate, visual perceptual quality, and task performance. Generally, the less real the face, the fewer bits needed when using the proposed compression method from the task-adaptive branch. More bits are needed vice versa. The second dimension enables the user to control how real the output is according to the current task needs. According to at least one further embodiment of the present aspects, the user can also choose to use just generic codebook-based representation and domain-adaptive codebook-based representation to generate the output without the task-adaptive branch, and only tune the first dimension 1310 of control. This scenario is marked as the Codebook-Only Results.

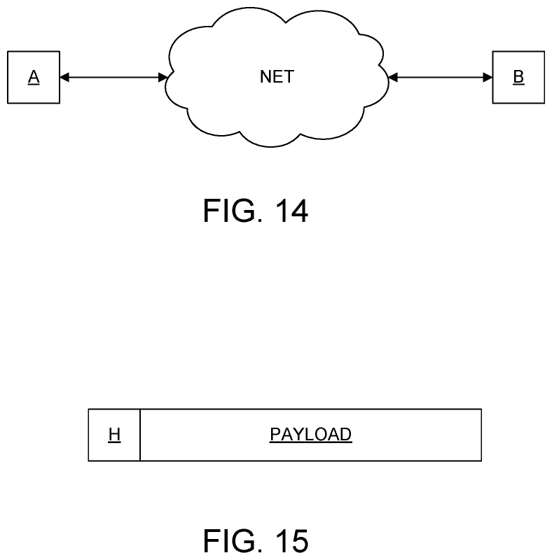

FIG. 14 shows two remote devices communicating over a communication network in accordance with an example of present principles in which various aspects of the embodiments may be implemented. According to an example of the present principles, illustrated in FIG. 14, in a transmission context between two remote devices A and B over a communication network NET, the device A comprises a processor in relation with memory RAM and ROM which are configured to implement any one of the embodiments of the method for encoding as described in relation with the FIG. 2, 4, 6, 8 or 10 and the device B comprises a processor in relation with memory RAM and ROM which are configured to implement any one of the embodiments of the method for decoding as described in relation with FIG. 3, 4, 6, 8 or 11. In accordance with an example, the network is a broadcast network, adapted to broadcast/transmit encoded images from device A to decoding devices including the device B. A signal, intended to be transmitted by the device A, carries at least one bitstream comprising coded data representative of at least one image along with metadata allowing to apply the entropy coding improvement information.

FIG. 15 shows an example of the syntax of such a signal when the at least one coded image is transmitted over a packet-based transmission protocol. Each transmitted packet P comprises a header H and a payload PAYLOAD. The payload PAYLOAD may carry the above described bitstream including metadata relative to signaling channel activity. In a variant, the payload comprises neural-network based coded data representative of image data samples and associated metadata, wherein the associated metadata comprises at least one of an indication of channel activity.

It should be noted that our methods are not limited to a specific neural network architecture. Instead, our methods can be used in other neural network architectures, for example, fully factorized neural image/video model, implicit neural image/video compression model, recurrent network based neural image/video compression model or Generative Model based image/video compressing methods.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, and inverse transformation. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
receiving a scalable latent representation comprising a generic codebook-based representation and a low-quality latent representation of a sequence of images;
obtaining a reconstructed generic codebook-based feature representative of image data samples reconstructed from the generic codebook-based representation;
decoding the low-quality latent representation to obtain a reconstructed low-quality image;
applying to the reconstructed low-quality image, a neural network-based embedding feature processing to generate a low-quality feature representative of a feature of image data samples; and
applying to the reconstructed generic codebook-based feature and to the low-quality feature, a neural network-based reconstruction processing to generate a reconstructed image adapted to a plurality of computer vision tasks including both machine consumption and human consumption.

2. The method of claim 1 further comprising applying to the reconstructed image, a neural network-based vision processing to generate a collection of vision processing results.

3. The method of claim 1, wherein the images are human-centric images.

4. The method of claim 1,
wherein the scalable latent representation further comprises a domain-adaptive codebook-based representation;
wherein the method further comprises obtaining a reconstructed domain-adaptive codebook-based feature representative of an appearance of image data samples reconstructed from the domain-adaptive codebook-based representation; and
wherein the neural network-based reconstruction processing further takes as input the reconstructed domain-adaptive codebook-based feature.

5. The method of claim 4, wherein the method further comprises receiving domain-adaptive combining weights associated with the domain-adaptive codebook-based representation and used by neural network-based reconstruction processing, the domain-adaptive combining weights determine how important the reconstructed domain-adaptive codebook-based feature is when combined with the reconstructed generic codebook-based feature.

6. The method of claim 4, wherein the method further comprises receiving low-quality combining weights associated with the low-quality latent representation and used by neural network-based reconstruction processing, the low-quality combining weights determine how important the low-quality feature is when combined with the reconstructed generic codebook-based feature and the reconstructed domain-adaptive codebook-based feature.

7. The method of claim 4, wherein the reconstructed generic codebook-based feature, the reconstructed domain-adaptive codebook-based feature and the low-quality feature are configured into tensor-shape data structures, and wherein a tensor-shape data structure associated with the reconstructed generic codebook-based feature, a tensor-shape data structure associated with the reconstructed domain-adaptive codebook-based feature and a tensor-shape data structure associated with the low-quality feature have the same dimensions.

8. An apparatus comprising a memory and one or more processors, wherein
the one or more processors are configured to:
receive a scalable latent representation comprising a generic codebook-based representation and a low-quality latent representation of a sequence of images;
obtain a reconstructed generic codebook-based feature representative of image data samples reconstructed from the generic codebook-based representation;
decode the low-quality latent representation to obtain a reconstructed low-quality image;
apply to the reconstructed low-quality image, a neural network-based embedding feature processing to generate a low-quality feature representative of a feature of image data samples; and
apply to the reconstructed generic codebook-based feature and to the low-quality feature, a neural network-based reconstruction processing to generate a reconstructed image adapted to a plurality of computer vision tasks including both machine consumption and human consumption.

9. The apparatus of claim 8, wherein the one or more processors are configured to apply to the reconstructed image, a neural network-based vision processing to generate a collection of vision processing results.

10. The apparatus of claim 8, wherein the images are human-centric images.

11. The apparatus of claim 8,
wherein the scalable latent representation further comprises a domain-adaptive codebook-based representation;
wherein the one or more processors are configured to obtain a reconstructed domain-adaptive codebook-based feature representative of an appearance of image data samples reconstructed from the domain-adaptive codebook-based representation; and
wherein the neural network-based reconstruction processing further takes as input the reconstructed domain-adaptive codebook-based feature.

12. The apparatus of claim 11, wherein the one or more processors are configured to receive domain-adaptive combining weights associated with the domain-adaptive codebook-based representation and used by neural network-based reconstruction processing, the domain-adaptive combining weights determine how important the reconstructed domain-adaptive codebook-based feature is when combined with the reconstructed generic codebook-based feature.

13. The apparatus of claim 12, wherein the one or more processors are configured to receive low-quality combining weights associated with the low-quality latent representation and used by neural network-based reconstruction processing, the low-quality combining weights determine how important the low-quality feature is when combined with the reconstructed generic codebook-based feature and the reconstructed domain-adaptive codebook-based feature.

14. The apparatus of claim 11, wherein the reconstructed generic codebook-based feature, the reconstructed domain-adaptive codebook-based feature and the low-quality feature are configured into tensor-shape data structures and wherein a tensor-shape data structure associated with the reconstructed generic codebook-based feature, a tensor-shape data structure associated with the reconstructed domain-adaptive codebook-based feature and a tensor-shape data structure associated with the low-quality feature have the same dimensions.

15. A method, comprising:
obtaining a sequence of images to encode;
applying to the sequence of images, a neural network-based generic embedding feature processing to generate a generic feature representative of a generic feature of image data samples;
obtaining a generic codebook-based representation based on the generic feature and on a generic codebook;
downsampling an image of the sequence of images to obtain a low-quality image;
encoding the low-quality image to obtain a low-quality latent representation; and
associating the generic codebook-based representation and the low-quality latent representation of the sequence of images to form a scalable latent representation of the sequence of images adapted to a plurality of computer vision tasks including both machine consumption and human consumption.

16. The method of claim 15, wherein the images are human-centric images.

17. The method of claim 15, wherein the method further comprises
applying to the sequence of images, a neural network-based domain-adaptive embedding feature processing to generate a domain-adaptive feature representative of an appearance of image data samples;
obtaining a domain-adaptive codebook-based representation based on the generic feature and on a domain-adaptive codebook; and
combining the domain-adaptive codebook-based representation, the generic codebook-based representation and the low-quality latent representation of the sequence of images to form a scalable latent representation of the sequence of images adapted to a plurality of computer vision tasks including both machine consumption and human consumption.

18. (canceled)

19. An apparatus comprising a memory and one or more processors, wherein
the one or more processors are configured to obtain a sequence of images to encode;
apply to the sequence of images, a neural network-based generic embedding feature processing to generate a generic feature representative of a generic feature of image data samples;
obtain a generic codebook-based representation based on the generic feature and on a generic codebook;
downsample an image of the sequence of images to obtain a low-quality image;
encode the low-quality image to obtain a low-quality latent representation; and
associate the generic codebook-based representation and the low-quality latent representation of the sequence of images to form a scalable latent representation of the sequence of images adapted to a plurality of computer vision tasks including both machine consumption and human consumption.

20. The apparatus of claim 19, wherein the images are human-centric images.

21. The apparatus of claim 19, wherein the one or more processors are configured to:
apply to the sequence of images, a neural network-based domain-adaptive embedding feature processing to generate a domain-adaptive feature representative of an appearance of image data samples;
obtain a domain-adaptive codebook-based representation based on the generic feature and on a domain-adaptive codebook; and
combine the domain-adaptive codebook-based representation, the generic codebook-based representation and the low-quality latent representation of the sequence of images to form a scalable latent representation of the sequence of images adapted to a plurality of computer vision tasks including both machine consumption and human consumption.

22-24. (canceled)
